(19) United States
(12) Patent Application Publication
(10) Pub. No.: US 2021/0170429 A1
(43) Pub. Date: Jun. 10, 2021

(54) IMPROVED SWIRL NOZZLE ASSEMBLY WITH HIGH EFFICIENCY MECHANICAL BREAK UP TO GENERATE MIST SPRAYS OF UNIFORM SMALL DROPLETS

(71) Applicant: DLHBOWLES, INC., Canton, OH (US)

(72) Inventors: Shridhar Gopalan, Westminster, MD (US); Evan Hartranft, Bowie, MD (US); Andrew D. Cameron, Chalfont, PA (US); Gregory A. Russell, Catonsville, MD (US)

(21) Appl. No.: 16/071,100

(22) PCT Filed: Jan. 27, 2017
(86) PCT No.: PCT/US2017/015477

§ 371 Date: Jul. 19, 2018

Related U.S. Application Data
(60) Provisional application No. 62/287,802, filed on Jan. 27, 2016.

(51) Int. Cl. B05B 1/34; B65D 83/14; B05B 1/14

(52) U.S. Cl. CPC B05B 1/3436; B05B 1/14; B65D 83/753

(57) ABSTRACT

Spray nozzle assembly (300) is configured to generate a swirled spray (312) with improved rotating velocity w and smaller uniform droplet size. Cup-shaped nozzle member (300) has a body portion (318) with a cylindrical side wall (320) surrounding a central longitudinal spray axis (322), a circular closed end wall (324) and an exit aperture (310) coaxial with the spray axis (322) and defined through the end wall (324). A fluid dynamic circuit (330) is formed in an inner surface (326) of end wall (324) and includes three inwardly tapered power nozzles (302, 304, 306) terminating in an interaction region (308) which is exhausted via the exit aperture (310). The power nozzles have respective longitudinal axes (334, 362, 382) offset with respect to the spray axis (322) with corresponding non-tangential angles of attack (352, 374, 394) configured to efficiently cause a fluid vortex in interaction region (308).

### REFERENCE TO RELATED APPLICATIONS

This application claims priority to and benefit of U.S. Provisional Application No. 62/287,802, filed Jan. 27, 2016 by Shridhar Gopalan, et al, and entitled “IMPROVED SWIRL NOZZLE ASSEMBLIES WITH HIGH EFFICIENCY MECHANICAL BREAK UP FOR GENERATING MIST SPRAYS OF UNIFORM SMALL DROPLETS (Three Power Nozzle Improved Mist Swirl Cup)” the disclosure of which is incorporated herein by reference.

This application is also related to (a) commonly owned US PCT application PCT/US15/22262 entitled “IMPROVED SWIRL NOZZLE ASSEMBLIES WITH HIGH EFFICIENCY MECHANICAL BREAK UP FOR GENERATING MIST SPRAYS OF UNIFORM SMALL DROPLETS”, (b) commonly owned U.S. provisional patent application No. 62/022,290 entitled “Swirl Nozzle Assemblies with High Efficiency Mechanical Break up for Generating Mist Sprays of Uniform Small Droplets (Improved Offset Mist Swirl Cup and Multi-Nozzle Cup)”, and (c) commonly owned U. S. provisional patent application Ser. No. 61/969,442, and entitled “Swirl Nozzle Assembly with High Efficiency Mechanical Break up for Generating Mist Sprays of Uniform Small Droplets (Mist Swirl Cup)” all of which are incorporated by reference. This application is also related to commonly owned U.S. Pat. No. 7,354,008 entitled “Fluidic Nozzle for Trigger Spray Applications” and to PCT application number PCT/US12/34293, entitled “Cup-shaped Fluidic Circuit, Nozzle Assembly and Method” issued on Apr. 8, 2008 to Hester et al (now WIPO Pub WO 2012/145537). The entire disclosures of all of the foregoing applications and patents are incorporated herein by reference.

### BACKGROUND OF THE INVENTION

### Field of the Invention

The present invention relates, in general, to spray nozzles configured for producing a “mist spray” that is particularly useful when spraying consumer goods such as air fresheners, cleaning fluids or personal care products. More particularly, this invention relates to a spray nozzle assembly for use with low-pressure, trigger spray or “product only” (meaning propellant-less) applicators to reliably and consistently generate a liquid spray containing droplets of a selected small size.

### Discussion of the Prior Art

Generally, a trigger dispenser for spraying consumer goods is a relatively low-cost pump device which is held in the hand and which has a trigger operable by squeezing or pulling the fingers of the hand to pump liquid from a container and through a nozzle at the front of the dispenser. Such dispensers may have a variety of features that have become common and well known in the industry. For example, the dispenser may be a dedicated sprayer that produces a defined spray pattern for the liquid as it is dispensed or issued from the nozzle. It is also known to provide adjustable spray patterns so that with a single dispenser the user may select a spray pattern that is in the form of either a stream or a substantially conical spray of liquid droplets.

Many substances are currently sold and marketed as consumer goods in containers with trigger sprayers. Examples of such substances include air fresheners, window cleaning solutions, personal care products and many other materials for other general spraying uses. Consumer goods using these sprayers are typically packaged with a bottle that carries a spray head which typically includes a manually actuated pump that a user aims at a desired surface or in a desired direction. The operating pressures of such manual pumps are generally in the range of 30-40 psi. The conical sprays are typically very sloppy, however, and spray an irregular pattern of small and large drops.

Sprayer heads recently have been introduced into the marketplace which have battery operated pumps in which one has to only press the trigger once to initiate a pumping action that continues until pressure is released on the trigger. These typically operate at lower pressures in the range of 5-15 psi. They also suffer from the same deficiencies as noted for manual pumps; plus, they appear to have even less variety in or control of the spray patterns that can be generated due to their lower operating pressures.

The nozzles for such dispensers are typically of the one-piece molded “cap” variety, with channels corresponding to offered spray or stream patterns that line up with the feed channel coming out of a sprayer assembly. See, for example, FIGS. 1A, 1B and 1C. These nozzles are traditionally referred to as “swirl cup” nozzles and the spray generated by such prior art nozzles is generally “swirled” within the nozzle assembly to form a spray (as opposed to a stream) having droplets scattered across a wide angle with droplets of varying sizes and velocities. Traditional swirl nozzles consist of one or more input channels positioned tangentially to the walls of a swirl chamber. The swirl chamber is either square with a length, width and depth or circular with a diameter and depth. The standard swirl nozzle requires a face seal and is arranged in such a way that the flow through the input channel(s) enters the swirl chamber which imparts a swirling or tangential velocity, setting up a vortex. The vortex then circulates downstream or distally and exits the swirl chamber through an exit which is typically concentric to the central axis of the nozzle assembly.

The problems with such nozzle assemblies include: (a) the relative lack of control of the spray patterns generated, (b) the frequent generation in such sprays of an appreciable number of both large and small diameter droplets which are randomly directed in a generally distal direction, and (c) a tendency of the resulting spray patterns to create sprayed areas pelted with large high velocity liquid droplets which result in sprayed liquid splattering or collecting and forming pools that have undesirable, break-out portions that stream down the sprayed surface. Sprays with large droplets are particularly undesirable if the user seeks to spray only a fine mist of liquid product. For many applications, it is preferred that the sprayed droplet Volumetric Mean Diameter (VMD or DV50) and domain of the distribution be as small as possible. It is also desired to minimize the operating pressure required to generate a preferred level of atomization. However, it was discovered that prior swirl cup nozzle configurations produced a sloppy spray in which droplets generated in the swirl chamber accelerated distally along the tubular lumen of the exit and tended to coagulate or recombine into droplets of irregular large sizes having excessive distally projected linear velocity. Coagulation is a phenomenon where small drops collide and recombine downstream of the nozzle exit, forming larger drops than those generated at the nozzle exit. Desirable droplets comprising a “mist spray” should have a diameter of sixty micrometers (60 μM) or less, and typical prior art swirl cups could not reliably create misting sprays.

Referring specifically to FIG. 1B, (from a technical journal) the successive stages in atomized spray development are illustrated, with increasing liquid injection pressure (left to right). The “Smooth Film” shown at the third stage in this sequence is sometimes referred to as a “sheet region” of what becomes a cone (at the onset of course atomization, and before fine atomization of the 6th stage). This “smooth film” is formed as the liquid flow within the nozzle approaches the outlet orifice (it should be noted that there is a cylinder of clear air at the center of the hollow spray, similar to the “eye” of a hurricane). Turning now to FIG. 1C, the stages of droplet break up are shown in detail for a standard swirl nozzle's cylindrical orifice which is formed as an axial length of straight cylindrical sidewall (where the sprayed fluid experiences peak frictional losses). The traditional or typical swirl nozzle orifice illustrated in FIGS. 1A-1C does not reliably generate and maintain a spray of fine mist-like droplets of selected size and velocity, partly because coagulation or coalescence occurs after atomization (that is, downstream or distally from where the view illustrated in FIG. 1C ends). Coagulation is the random action of droplets colliding and combining to form larger droplets, resulting in an overall larger particle size distribution. This unsatisfying coagulation/combination phenomenon is a nozzle class-defining problem which plagues users of the prior art aerosol nozzles.

To produce a cost-effective substitute for the traditional swirl cup which would reliably generate droplets of a selected small size (i.e., with a droplet diameter of 60 μM or less) and which would prevent creation of the splattering large droplets of traditional swirl cups, a cup-shaped swirl nozzle assembly recently developed by the applicants herein to provide a spray with high efficiency mechanical breakup (“HE-MBU”) of fluid droplets was observed to project that spray of fine droplets in a selected direction along a distally aligned axis to generate mist sprays with small uniform droplets. This assembly consisted of two input channels or power nozzles of a selected width and depth, positioned tangentially to the walls of the interaction region. The interaction region of such devices was either square, with length, width & depth dimensions, or circular, with diameter and depth dimensions. That geometry required a face seal where the nozzle abuts the spray head on which it is mounted, and was arranged so that liquid flows through the power nozzles and enters the interaction region with a tangential velocity Uθ, setting up in the interaction chamber a liquid vortex with a radius r and an angular velocity ω=Uθ/r. The liquid vortex circulates downstream and exits the interaction region through an exit aperture that is concentric to the central axis of the nozzle. In accordance with applicants' recent work, a cup-shaped high-efficiency mechanical break-up (“HE-MBU”) nozzle member included a cylindrical sidewall surrounding a central axis and a distal end wall having an interior surface and an exterior or distal surface. A central outlet or exit aperture through the end wall provided fluid communication between the interior and exterior of the cup-shaped member. Defined in the substantially circular interior surface of the distal wall were first and second power nozzles, each providing fluid communication to and terminating in a central interaction region or swirl vortex-generating chamber defined in the end wall. Each power nozzle defined a tapering channel or lumen of selected constant depth but narrowing width which terminated in a power nozzle outlet or opening having a selected power nozzle width (P_{W}) at its intersection with the interaction chamber.

The first power nozzle had an inlet which was defined in the interior surface of the distal wall proximate the cylindrical sidewall so that pressurized inlet fluid which flowed distally along the interior sidewall of the cup entered the first power nozzle inlet. The fluid accelerated along the tapered lumen of first power nozzle to a corresponding nozzle outlet where the fluid entered one side of the interaction chamber. The second power nozzle was similar to the first and also received at its inlet the pressurized inlet fluid which flowed distally along the interior sidewall of the cup. The inlet fluid accelerated along the tapered lumen of second power nozzle to its corresponding nozzle outlet, where it entered the side of the interaction chamber opposite to the first nozzle outlet. The interaction chamber, or swirl-generating region, was defined between the power nozzle outlets with a substantially circular cross-section incorporating a cylindrical sidewall coaxial with the nozzle's central axis and coaxially aligned with a central outlet orifice which provided fluid communication between the interaction chamber and the exterior of the cup so that the outlet's swirling spray was directed along that central axis.

The input channels, or power nozzles, were of a selected depth, and were configured to inject pressurized fluid tangentially into the interaction region. The circular interaction region preferably had a diameter which was in the range of 1.5 to 4 times the power nozzle outlet depth Pd, and preferably had a face seal and was arranged such that the fluid flowed from the power nozzles and entered the interaction region with a higher tangential velocity Uθ than the velocity of the fluid entering the nozzle, setting up a rapidly spinning or swirling liquid vortex with radius r and an angular velocity ω=Uθ/r. The vortex issued from the interaction region through the exit aperture which was aligned with the central axis of the nozzle cup. This configuration caused swirling fluid droplets generated in the swirl chamber to accelerate into a highly rotational flow which issued from the exit as very small droplets which were prevented from coagulating or recombining into larger droplets. The depth of the dynamic fluid circuit was found to affect the atomization efficiency of the nozzle, since as the depth was reduced, the volume of the interaction region was reduced. It was observed that as depth of the interaction region (IR) increased, more kinetic energy was required to generate a rotational velocity w equivalent to that available with a shallower swirl chamber. Hence, as IR depth increased, atomization efficiency was reduced. Experimental data indicated that circuit depth could be reduced to as low as 0.20 mm before boundary layer effects started to cause losses in atomization efficiency.

Reduced shear losses and larger rotating or angular velocity ω combined with reduction in coagulation resulted in the spray output exhibiting improved atomization. The VMD of the spray droplet distribution was reduced (i.e., with a droplet diameter of 60 μM or less) for a typical pressure and generated smaller and more uniform droplets than the prior art swirl cup at any given pressure. Measurements of the spray generated with this configuration showed mist sprays with very high rotating velocity and very little recombination of the mist drops, even when measured at nine (9) inches from the nozzle. The exit geometry lumen preserved the rotational energy of the small droplets created in the interaction chamber more effectively than the standard cylindrical exit orifice of FIGS. 1A, 1B and 1C and was somewhat effective at conserving the small droplet size.

The exit aperture geometry of applicant's recently developed device was characterized as a non-cylindrical exit channel having three main features: (1) a proximal converging segment having a rounded shoulder of gradually decreasing inside diameter which is upstream of a minimum exit diameter segment; (2) a rounded central channel segment defining a minimum exit diameter, with little to no cylindrical land; and (3) a distal diverging segment having a rounded shoulder or flared horn-like segment of gradually increasing inside diameter downstream of the minimum exit diameter. Features (1) and (2) were observed to reduce shear losses and improve w. Feature (3) allowed improved expansion of the spray cone which formed downstream of the exit orifice's minimum exit diameter. But tooling applicant's recently developed nozzles revealed mold-making issues. In some configurations, any misalignment between the two halves of the tool would have resulted in a step at the minimum cross sectional area of the exit orifice, and this potentially changed that critical area, or even worse, increased shear losses due to wall friction, since any imperfections in the exit orifice profile were likely to neutralize any gains in atomization. Also, the diameter of the tool's B side orifice pin at the shut off location increased by an order of magnitude, and was subject to substantially less tool wear and maintenance than the original tool's 0.300 mm pin. While exit orifices with downstream radii had been observed to generate greater atomization efficiency than those without downstream radii, significant performance gains required very large cone angles (e.g., <100°) and were not practical for consumer spray applications. So the applicants continued working to make further improvements.

### SUMMARY OF THE INVENTION

Although the applicants' recently developed swirl nozzle structure utilizing two opposed power nozzles as described above provided significant advantages over previous standard swirl nozzles (of FIGS. 1A, 1B and 1-C), it has been found that further improvements in the sprays are possible. Accordingly, the present invention provides such improvements by employing three substantially alike power nozzles equally spaced around an interaction chamber and its exit orifice, with the nozzles also having offset ratios and angles of attack differing from the prior devices to generate surprisingly enhanced atomization. Briefly, the applicants' new “tri-power HE-MBU” nozzle configuration development work included experiments which studied something similar to the dimensional parameter referred to as an offset ratio, but with an important difference. The tri-power HE-MBU nozzle configuration of the present invention uses a newly developed offset factor, to provide something which differs from the applicants' prior power nozzle embodiments. The offset factor is defined as the ratio of power nozzle width to the interaction region diameter (Pw/IRd), and the best atomization performance was observed from prototypes with a three power nozzle array with equally spaced first, second and third power nozzles, each with an offset factor between 0.20 and 0.50. In the present invention, an offset factor (Pw/IRd) of 0.244 is preferred. Further, the three nozzles are angled with respect to the interaction chamber so that the inrushing fluid's angle of attack, or the angle at which flow is directed into the interaction region, is in the range of 30-50 degrees and preferably about 40 degrees from a line tangential to the interaction chamber at the point of intersection with the center line (or spray axis) of the power nozzle. Improved efficiency occurs by employing the flow vortex set up in the interaction region to accelerate the liquid jets from the power nozzles, without the need for immense converging walls in the power nozzles which rob the flow of kinetic energy, to generate large angular velocities and superior atomization performance.

The energy contained in the interaction region is maintained by limiting the circuit depth to be as small as flow requirements and boundary layer effects permit, typically ranging from 0.2-0.5 mm (preferably 0.28 mm). Additionally, the length of the exit orifice is limited and sharp edges are filleted where possible. The preferred exit orifice profile reduces shear losses and maximizes cone angle to discourage coagulation. Lastly, the three-power-nozzle embodiment may also be configured with multiple exit orifices in a single cup shaped nozzle member, including an enhanced structure for each exit orifice. The work to develop new the nozzle assemblies (and methods) of the present invention are intended to overcome the problems of the prior art and reliably generate and maintain a spray of fine mist-like droplets of selected size and velocity, partly by avoiding coagulation or coalescence after atomization. The applicants have learned that coagulation can be avoided by minimizing droplet collisions and combinations to avoid reformation into larger droplets, resulting in an overall smaller and more uniform particle size distribution. Droplet collisions are minimized by maximizing the cone angle for a given mass flow rate, so the probability of the coagulation phenomena is reduced. The development work leading to the present invention provided further refinements in a High Energy-Mechanical Break-Up (“HE-MBU”) nozzle assembly which relies, in part, on an outlet configuration where the axial length is as short as possible given present limitations of injection molding.

The purpose of the relatively short axial length of the outlet orifice in the HE-MBU nozzle of the present invention is to mitigate frictional loses and encourage the unrestricted formation and expansion of a rotating film. The most significant difference in the outlet of this applicant's recently developed (and separately applied-for) MBU Nozzle assemblies and the nozzle assembly of the present invention is that the nozzle assembly of the present invention provides a larger cone angle (or half angle). It is important to note that coagulation, or coalescence, is a phenomena that occurs after atomization (that is, distally or downstream from the nozzle's outlet orifice). Applicant's lab work has confirmed observations that coagulation arises from the random action of droplets colliding and combining to form larger droplets, resulting in an overall larger particle size distribution. Unless mitigated, this coagulation phenomenon is a feature of all aerosols. In accordance with the method of the present invention, by maximizing the cone angle for a given mass flow rate, the probability of the coagulation phenomena occurring is reduced. The two most important orifice dimensions that vary across all HE-MBU embodiments of the present invention include:

(a) the outlet (or spray emitting) orifice diameter, which has been selected to be in a range of 0.20 mm to 1.0 mm. This dimension is varied based on flow requirements of the nozzle spray application; and
(b) the orifice's internal cylindrical land length (along the spray axis), which has been selected to be in a range of 0.01-1.0 mm. This dimension is varied based on cone angle requirements of the application. Technically this should be ≤0.05 mm to avoid restricting the cone, but it is increased on occasion—at the expense of larger droplet size, to prevent the cone from impinging on product packaging.

The present invention further includes an improved method for generating a swirled fluid spray with reduced coagulation and a consistently small droplet size, which incorporates the steps of providing an exit aperture in an end wall of a nozzle body and forming a fluid dynamic circuit having an interaction chamber surrounding the exit aperture in the end wall. The step of forming the fluid dynamic circuit includes forming three fluid accelerating power nozzles spaced around and intersecting the interaction chamber and having longitudinal axes offset with respect to the exit aperture. The method further includes introducing a pressurized fluid into the fluid power nozzles to direct the fluid to the interaction chamber and shaping the power nozzles to accelerate the fluid to generate a fluid vortex in the interaction chamber, with the vortex exiting the nozzle through the exit aperture to produce a swirled output spray. The method also includes providing an improved angle of attack for the fluid to be sprayed by angling each fluid accelerating power nozzle at the selected acute attack angle with respect to a line tangent to the interaction chamber at the point of intersection of the power nozzle with the interaction region to generate the fluid vortex.

In summary, then, the present invention comprises a spray nozzle configured to generate a swirled spray with improved rotating or angular velocity ω, resulting in smaller and more uniform sprayed droplet size. The device includes a cup-shaped nozzle body having a cylindrical side wall surrounding a central longitudinal axis and a circular closed end wall, with an exit aperture coaxial with the side wall passing through the end wall. A fluid dynamic circuit is formed in an inner surface of the end wall, the fluid dynamic circuit including three (first, second and third) inwardly tapered power nozzles terminating in an interaction region surrounding the exit aperture, where the power nozzles are equally spaced around the interaction region and have first, second and third respective longitudinal axes which are offset with respect to the exit aperture, so that fluid under pressure introduced into the dynamic fluid circuit flows along the power nozzle lumens and into the interaction region to generate a fluid vortex which exits the exit aperture as a swirled spray. The longitudinal axes of each of the first, second and third power nozzles intersect the interaction region at an acute angle of attack with respect to a line tangent to the interaction region at the point of intersection. In the preferred form of the invention, each of the first, second and third power nozzles have an angle of attack of about 40°. The power nozzles taper to a selected power nozzle outlet width (e.g., 0.39 mm) and have a uniform depth (e.g., 0.28 mm) for a selected interaction region diameter (e.g., 1.6 mm) which exhausts or sprays distally along the central spray axis through an outlet orifice having a selected smallest (throat) diameter (e.g., 0.39 mm). The three power nozzles are spaced around the interaction region, and aimed with an offset with respect to the outlet orifice, entering the interaction region at improved angles of attack to create a consistent, strong vortex that maintains its velocity in the interaction region as the fluid swirls toward the outlet, providing an improved mechanical breakup of the fluid to produce small droplets which exit axially through the central outlet orifice.

The present invention provides a cost-effective yet much improved substitute for traditional swirl cups, and reliably generates droplets of a selected small size while more effectively preventing the creation of splattering large droplets that occurs with traditional swirl cups.

### BRIEF DESCRIPTION OF THE DRAWINGS

The foregoing, and additional objects, features and advantages of the present invention will be further understood by those of skill in the art from a consideration of the following detailed description of preferred embodiments, taken with the accompanying drawings, in which:

FIG. 1A is a diagram of fluid flow inside a traditional typical swirl nozzle's interaction region, as taught in the prior art;

FIG. 1B is a diagram illustrating the successive stages in atomized spray development with increasing liquid injection pressure for the traditional swirl nozzle of FIG. 1A, as taught in the prior art;

FIG. 1C is a diagram illustrating the stages of droplet break up for the cylindrical outlet orifice of the traditional swirl nozzle of FIG. 1A, as taught in the prior art.

FIG. 2 is a bottom plan view of one of this applicants' recently developed fluid nozzle members having a pair of opposed power nozzles;

FIG. 3 is a cross-section taken along lines 3-3 of FIG. 2;

FIG. 4 is a bottom perspective cutaway view of FIG. 2;

FIG. 5 is an enlarged view of the power nozzles of FIG. 4;

FIG. 6 is an enlarged cross-sectional view of the outlet orifice of the device of FIG. 2;

FIG. 7 is a bottom plan view of another of this applicants' fluid nozzle members having two pairs of opposed fluid nozzles supplying fluid in the same direction to corresponding interaction regions;

FIG. 8 is a bottom plan view of another of this applicants' fluid nozzle members having two pairs of fluid nozzles supplying fluid in opposite directions to corresponding interaction regions; and

FIG. 9 is a cross-sectional view taken at lines 9-9 of FIG. 8 and illustrating diverging exit throats.

FIG. 10 is a partial cross-sectional view of the improved dynamic fluid circuit spray nozzle member and method of the present invention, illustrating the spray nozzle mounted in a typical spray dispenser;

FIG. 11 is a bottom plan view of the nozzle member of FIG. 10, illustrating the interior of the nozzle member removed from the sprayer and having first, second and third power nozzles incorporating selected offset factors and angles of attack to provide improved performance; and

FIG. 12 is an enlarged cross-sectional view taken along lines 12-12 of the nozzle of FIG. 11.

### DESCRIPTION OF THE INVENTION

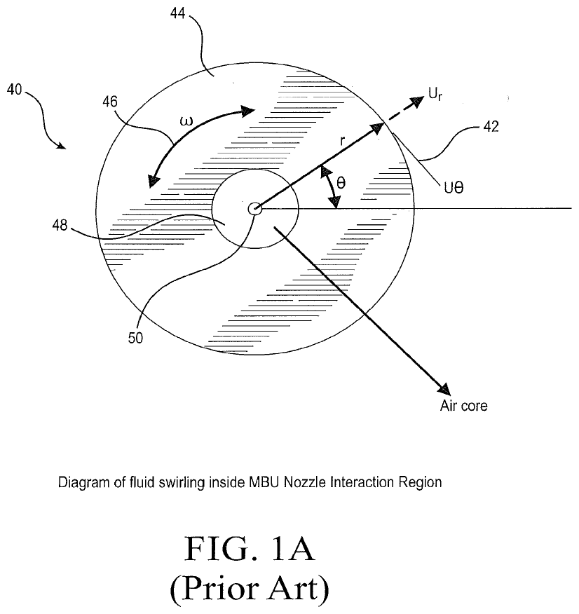

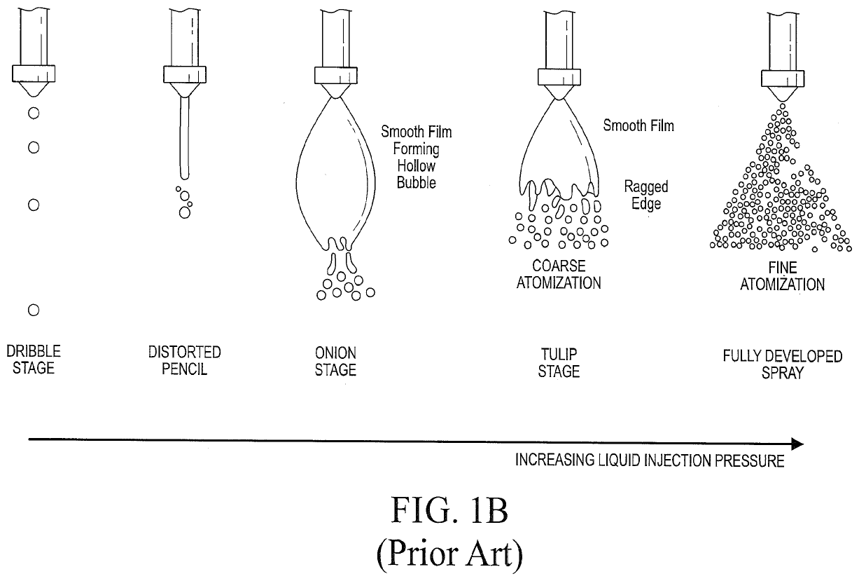

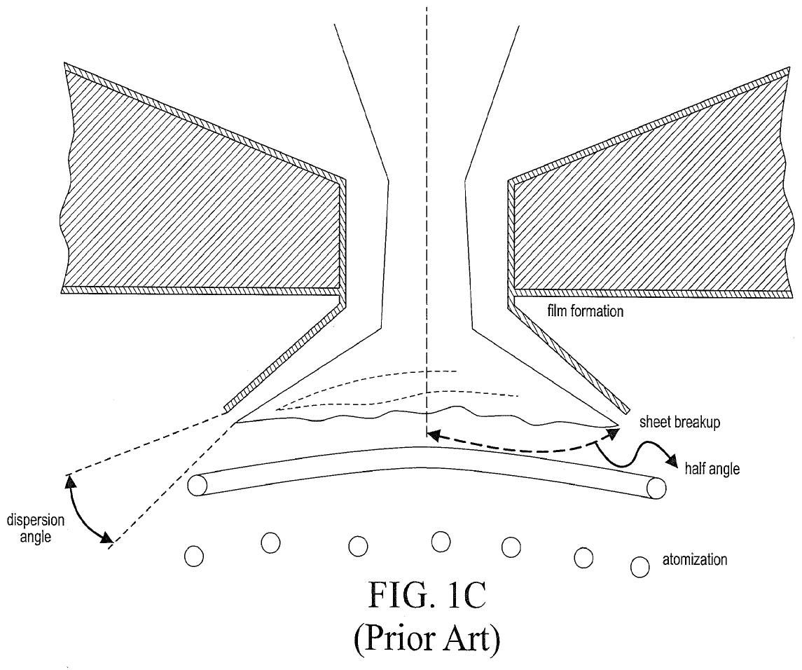

Turning first to a more detailed description of the prior art in order to provide a background for a thorough understanding of the features and advantages of the present invention, it is noted that, as diagrammatically illustrated at 40 in FIG. 1A, swirl nozzles used in standard prior art sprayers typically consisted of an input channel positioned to supply fluid under pressure tangentially, as indicated by arrow 42, to a swirl chamber 44. The swirl chamber 44 may be square, with desired length, width and depth dimensions, or cylindrical, with desired circular radius and depth dimensions. In the illustration, the swirl chamber 44 is circular in cross section with a radius “r”. Typically, the geometry of a fluid spray nozzle supplies a fluid to be sprayed to the swirl chamber 44 and imparts a tangential velocity Uθ, setting up a fluid vortex, indicated by arrow 46, having a maximum radius “r” and an angular velocity ω=Uθ/r in region 44. The fluid vortex 46 circulates around the swirl chamber, moves distally or downstream and exits the swirl chamber through an exit opening 48 having a tubular lumen that is concentric to a central axis 50 of the nozzle that is generally perpendicular to the diameter of the swirl chamber. This configuration causes the droplets generated in the swirl chamber to accelerate distally (away from the nozzle) along the tubular lumen of the exit opening and to swirl around the axis to be expelled as a spray (also shown in FIG. 1C). Prior swirl nozzle assemblies have been configured for the purpose of providing a spray of fine droplets (i.e., with a droplet diameter of 60-80 μM or less, but larger than 10 μM) with mechanical breakup of the fluid droplets, and then to project that spray in a selected direction along the distally aligned axis of the tubular or cylindrical exit lumen to generate mist-like sprays with small droplets, but those droplets were not really uniform enough, and recombined or coagulated to make droplets of varying sizes, as described above.

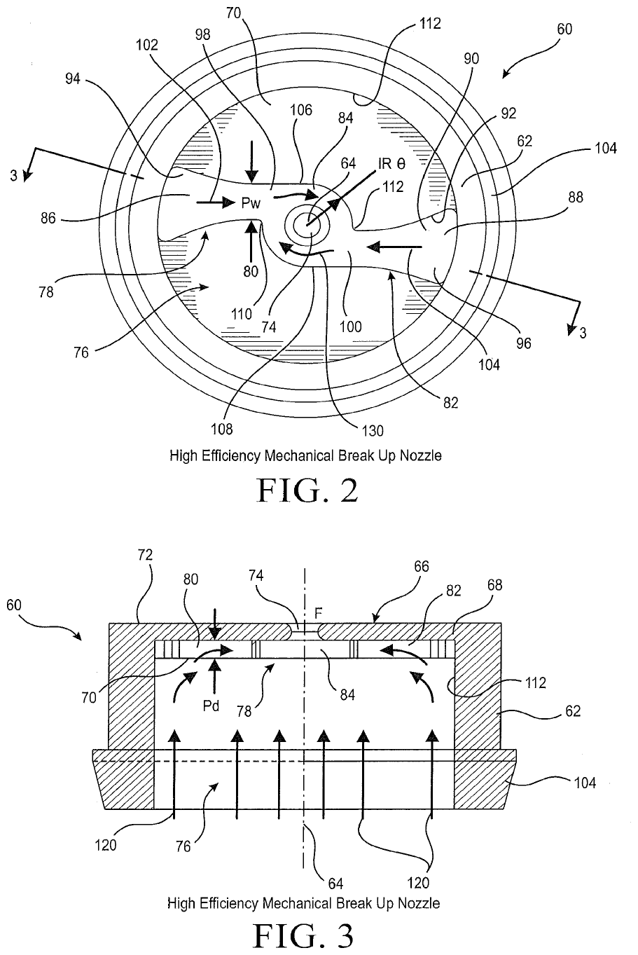

In an effort to overcome the problems with the standard swirl nozzles of FIGS. 1A-1C, this applicant recently developed fluid nozzle members 60, illustrated in FIGS. 2-9 which are also described and illustrated in (a) commonly owned US PCT application PCT/US15/22262 entitled “IMPROVED SWIRL NOZZLE ASSEMBLIES WITH HIGH EFFICIENCY MECHANICAL BREAK UP FOR GENERATING MIST SPRAYS OF UNIFORM SMALL DROPLETS”, (b) commonly owned U.S. provisional patent application No. 62/022,290 entitled “Swirl Nozzle Assemblies with High Efficiency Mechanical Break up for Generating Mist Sprays of Uniform Small Droplets (Improved Offset Mist Swirl Cup and Multi-Nozzle Cup)”, and (c) commonly owned U.S. provisional patent application No. 61/969,442, and entitled “Swirl Nozzle Assembly with High Efficiency Mechanical Break up for Generating Mist Sprays of Uniform Small Droplets (Mist Swirl Cup)” all of which are incorporated by reference. The applicants' recently developed HE-MBU nozzle assemblies illustrated in FIGS. 2-9 avoided many of the problems of previous spray devices of FIGS. 1A-1C while improving the creation and preservation of small droplets which issued at high angular velocity. The HE-MBU nozzles provide two improvements over traditional swirl nozzles of FIGS. 1A-1C, namely: (1) a swirled spray with rotating or angular velocity ω increased with respect to previous devices, resulting in smaller droplet size, and (2) a swirled spray with reduced coagulation, further reducing and maintaining smaller droplet size.

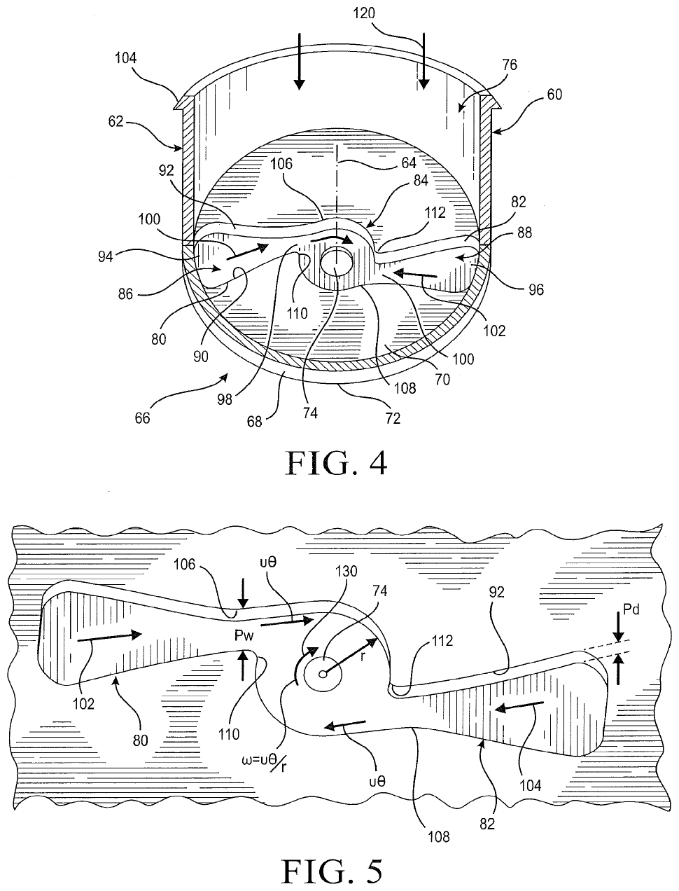

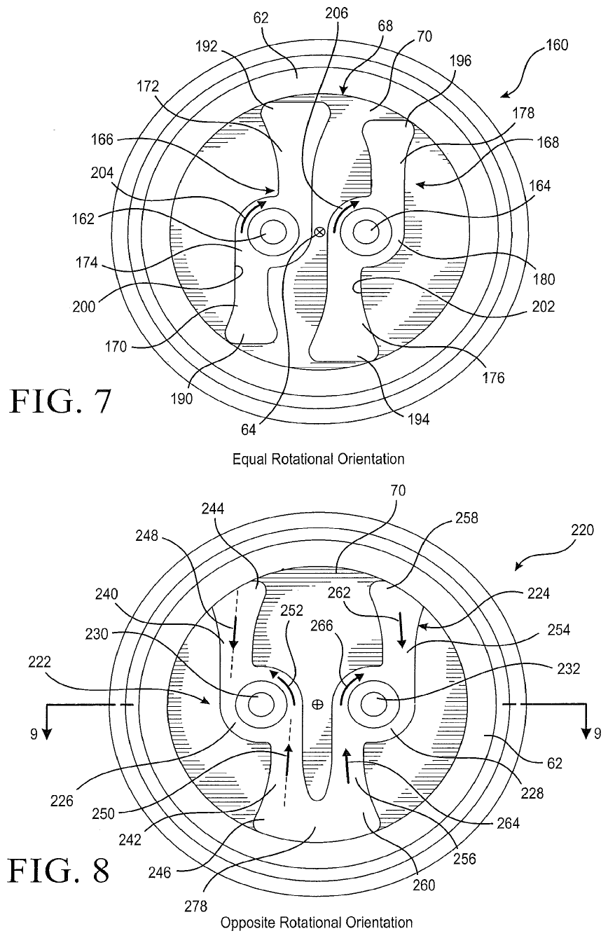

Applicants' recently developed cup-shaped nozzle 60 (as viewed in FIGS. 3 and 4) has a body consisting of a cylindrical sidewall 62 surrounding a central axis 64, and a closed upper end generally indicated at 66. The closed end is formed by a substantially circular distal end wall 68 having an interior surface 70 and an exterior or distal surface 72. A central outlet channel, or exit aperture 74, in the end wall provides fluid communication between the interior 76 of the cup, which receives fluid under pressure from, for example, a dispenser spray head, and the exterior of the cup, or ambient, to which the fluid spray is directed. Defined in the distal wall 68, in the interior surface 70 thereof, is a dynamic fluid circuit 78 consisting of first and second opposed power nozzles or channels 80 and 82, each extending generally radially inwardly from the side wall 62 to a substantially circular central interaction chamber 84. The interaction chamber 84 is similar to the diagrammatic chamber 44 of FIG. 1, is formed in the interior surface of wall 68, and defines a lumen which surrounds and is concentric to the exit aperture 74, shown in the enlarged view of FIG. 7.

As illustrated in the bottom plan view of FIG. 2, and in the inner perspective cut-away view of FIG. 4, wherein a portion of the side wall 62 has been removed, and in the enlarged view of FIG. 5, the power nozzles 80 and 82 formed in the top wall 68 are defined by respective tapering channels, or lumens 86 and 88, respectively, having a continuous, substantially flat floor 90 formed in the wall 68 and a substantially perpendicular continuous sidewall 92 of a selected constant height or depth Pd, which defines its depth in the wall 68. Similarly, the generally circular region of interaction chamber 84 is formed by a continuation of the lumen floor 90 and sidewall 92 and also has the same depth Pd. Preferably, the sidewall 92 for the power nozzles 80 and 82 and the interaction chamber 84 is smoothly curved around enlarged end regions 94 and 96 near the inner surface of nozzle wall 62 and then extends generally radially inwardly toward the chamber 84 to produce a narrowing flow path having a minimum width Pw. The power nozzle chambers 80 and 82 taper inwardly toward respective narrow power nozzle outlet regions 98 and 100, the chambers extending along respective axes 102 and 104, respectively. The power nozzle outlet regions terminate at, and merge smoothly into, the interaction chamber 84.

Each of the power nozzle outlet regions has a relatively narrow selected power nozzle exit width P_{W} at its intersection with the interaction chamber, with the generally radial axes of the power nozzles 80 and 82 being offset in the same direction from the central axis 64 of the nozzle 60. This offset causes the fluid flowing in the power nozzles to enter the interaction chamber 84 substantially tangentially to produce a swirl vortex in the interaction chamber which then flows out of the nozzle outlet 74 through the end wall 68. In the illustrations of FIGS. 2, 4 and 5 it will be seen that the power nozzles are each directed to the left of the axis 64 (viewed in the direction of fluid flow) to produce a clockwise swirl, or fluid vortex, around the outlet 74. As illustrated at 106 and 108, the left sidewall of each power nozzle (viewed in the direction of flow) merges substantially tangentially with the interaction chamber sidewall to cause the desired swirl in the fluid flow from the nozzle. Opposite the regions 106 and 108, the side wall 92 bends abruptly at the junctions of the power nozzles 80 and 82 with the interaction chamber, as illustrated at 110 and 112, to form shoulders that cause fluid flow in the interaction chamber to bypass the power nozzle outlets and to continue its swirling motion to exit at outlet 74 instead of flowing back into one of the opposed power nozzles. The smoothly curved sidewall 92 and narrowing lumens causes a smooth flow of fluid into the interaction chamber and around the outlet 74 so it is ejected in a fine mist having the desired consistent droplet size. Surrounding the bottom edge of the cup-shaped nozzle 60 is an optional flange or barb 104 which provides a connection interface with a dispenser spray head in known manner, as by engaging a corresponding shoulder on the interior surface of the spray head outlet.

In operation, a pressurized inlet fluid, indicated by arrows 120 in FIGS. 3 and 4, flows from a suitable dispenser spray head into the interior 76 of the nozzle 60. The pressurized inlet fluid flows distally along the interior surface 112 of the cylindrical sidewall 62, and upon reaching the end wall 68, the fluid 120 enters the enlarged regions of power nozzle lumens 86 and 88 that are formed and defined in the interior surface of the distal wall 68 and is directed inwardly toward the interaction region and to the exit aperture 74. The axes 102 and 104 of the nozzles are offset with respect to the exit aperture 74, and with respect to each other, and the inward taper of the lumens accelerates the fluid flowing along them toward and through the intersection of the power nozzle outlets 98 and 100 with the interaction chamber 84. The offset causes the fluid from the opposed power nozzles to enter opposite sides of the interaction region 84 to introduce a clockwise swirling motion in the flowing fluid, forming a vortex indicated by arrow 130 in the fluid which then flows downstream out of the exit aperture so that a fluid spray is directed along the central axis 64 out of the nozzle 60.

The interaction chamber is circular and preferably has the same depth as each power nozzle, and is arranged so that the fluid flows from the power nozzles and enters the interaction region with a tangential velocity Uθ than is higher than the velocity of the fluid entering the nozzles, setting up a vortex with radius r and a high angular velocity ω=Uθ/r. The rapidly spinning or swirling vortex then issues from interaction region through the exit aperture which is aligned with the central axis of the nozzle cup. This configuration causes swirling fluid droplets that are generated in the swirl chamber to accelerate into a highly rotational flow which issues from the exit as very small droplets.

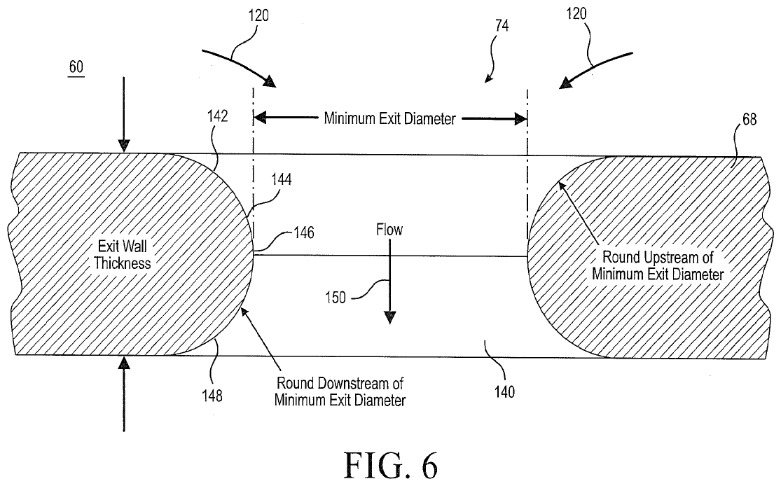

The exit aperture 74 of the nozzle 60 of the applicants' prior art device incorporated an outlet or exit geometry, illustrated in the enlarged view of FIG. 6, which was configured in end wall 68 to minimize fluid shear losses and maximize the spray cone angle. The geometry was characterized as a non-cylindrical exit channel 140 having a substantially circular cross-section and was defined by three features, labeled in the Figure as: (1) a proximal converging entry segment 142 which has a rounded shoulder of gradually decreasing inside diameter (from the interior of the nozzle); (2) a rounded central channel segment 144 which is upstream of the converging entry segment and defines a minimum exit diameter segment 146 with little to no cylindrical land; and (3) a distal diverging exit segment 148 which has a rounded shoulder or flared horn-like segment of gradually increasing inside diameter downstream of the minimum exit diameter 146. The vortex generated in the interaction region flows into entry segment 142 of the exit aperture, through the minimum diameter segment 146 and out of the exit segment 148 to the atmosphere, as indicated by flow arrow 150. Features (1) and (2) reduced shear losses and maximized w. Feature (3) allowed maximum expansion of a spray cone that formed downstream of the minimum exit diameter to prevent VMD losses due to coagulation.

For applicants' recently developed nozzles of FIGS. 2-9 an offset ratio, of the spray nozzle was defined as the ratio of power nozzle depth (Pd) to the interaction region diameter (IRd), and expressed as (Pd/IRd). Prototypes with offset ratios ranging from 0.30 to 0.50 were tested, and it was found that sprayed fluid atomization efficiency increased as this ratio approached what was discovered to be an optimum value of 0.37. The depth “Pd” of the dynamic fluid circuit of nozzle 60, which includes the power nozzle and interaction chambers (80, 82 and 84 in FIG. 2), also affected the atomization efficiency of the nozzle. As the depth was reduced, the volume of the interaction region was reduced. As the depth increased, more kinetic energy was required to generate equivalent w relative to a shallower swirl chamber. Hence, as the depth increased, atomization efficiency was reduced. Experimental data indicated that circuit depth could be reduced as low as 0.20 mm before boundary layer effects started to cause losses in atomization efficiency.

For some of applicants' recently developed nozzles, the exit orifice profile (described above with respect to FIG. 6) was modified to produce equivalent atomization with only the lead-in radius 142 on the upstream edge of the exit orifice. By removing the downstream radius 148 and leaving a sharp edge, the shut off of the two halves of an injection molding tool (not shown) changed location, and the tooling structure became significantly more robust in terms of tool side alignment, tool wear, and required maintenance. In the previous configuration, any misalignment between the two halves of the tool would result in a step at the minimum cross sectional area of the exit orifice, any imperfections in the exit orifice profile 150 could potentially change that critical area, or even worse, increase shear losses due to wall friction to neutralize any gains in atomization.

FIG. 7 illustrates another of applicants' recently developed fluid spray nozzles 160 in which multiple (e.g., first and second) nozzle exit apertures, or orifices 162 and 164 are provided and configured to generate sprays having an equal rotation orientation for applications that demanded larger flow rates than the 30-40 mLPM @40 psi of prior nozzles. This configuration incorporated a slightly scaled-down nozzle geometry, wherein two separate fluid power nozzle circuits 166 and 168, oriented to produce same-direction rotation, were formed in the interior surface 70 of distal wall 68. The first power nozzle circuit 166 incorporates opposed power nozzle chambers 170 and 172 to provide fluid communication to and terminate in a corresponding swirl vortex generating interaction region 174. The second power nozzle circuit 168 incorporates opposed power nozzle chambers 176 and 178 and provides fluid communication to and terminates in a corresponding swirl vortex generating interaction region 180. The power nozzle circuits 166 and 168 are similar to the nozzle circuit described with respect to FIGS. 2-5, with each power nozzle chamber defining a tapering channel of selected constant depth Pd and narrowing width Pw which terminates in a corresponding power nozzle outlet or opening having a selected power nozzle width (P_{W}) at its intersection with its corresponding interaction region.

The power nozzle circuits 166 and 168 were disposed equidistantly on opposite sides of the central axis 64 of nozzle 160 in this prior art configuration, were generally parallel to each other, and were formed in the inner surface 70 of the end wall 68 to have their inlet ends 190, 192 for circuit 166, and 194,196 for circuit 168 formed in the interior surface 70 of distal wall 68 proximate the cylindrical sidewall 62. Pressurized inlet fluid flowed distally into the interior of the cup and along sidewall 62 to enter the inlet ends of both fluid circuits and flowed inwardly along each power nozzle to enter the respective interaction regions. As described above, the power nozzles incorporated continuous vertical sidewalls 200 and 202 which defined tapered chambers, or lumens which caused the fluid to accelerate along the power nozzles.

As seen in FIG. 7, each interaction or swirl region 174 and 180 is defined between its respective power nozzles as a chamber of substantially circular configuration, having cylindrical sidewalls (formed by continuations of sidewalls 200 and 202). The interaction regions are equally spaced on opposite sides of, and parallel to, the distally projecting central axis 64 of distal end wall 68 and are coaxially aligned with their respective outlet channels or exits 162 and 164. It is noted that the axes of the power nozzles are offset with respect to their interaction regions to produce a clockwise swirling motion in the fluid in both regions, as indicated by arrows 204 and 206. This structure provides fluid communication between each interaction chamber and the exterior of the cup so that spray is directed out of the nozzle 160 in similar vortexes along two parallel axes spaced from but parallel to the cup's central axis 64.

FIG. 8 illustrates another of applicant's recently developed configurations providing an opposing rotation fluid nozzle assembly 220 also having a cup-shaped cylindrical sidewall 62 surrounding a distally projecting central axis 64 and terminating in a distal end wall 68 having a circular interior surface 70 and an exterior or distal surface 72. First and second outlet channel or exit orifices 230 and 232 each provide fluid communication between the interior and exterior of the cup. Formed in the interior surface 70 of the distal wall 68 of nozzle 220 are first and second separate fluid power nozzle circuits 222 and 224 incorporating respective interaction regions 226 and 228 surrounding their respective exit orifices 230 and 232. The first fluid circuit 222 incorporates a pair of opposed power nozzle channels 240 and 242 each extending inwardly from corresponding enlarged inlet regions 244 and 246 at the side wall 62 of the nozzle assembly 220 which receive fluid from a suitable source. The channels taper inwardly to merge with diametrically opposite sides of interaction region 226. The respective axes 248 and 250 of these channels are offset with respect to their corresponding interaction region 226 to produce a swirling fluid flow in region 226; in the illustrated case, each offset is to the right side of the exit orifice 230 to produce a counter-clockwise flow 252 in the interaction region.

Similarly, the second fluid circuit 224 incorporates a pair of power nozzle channels 254 and 256 extending inwardly from enlarged inlet regions 258 and 260 at the side wall 62 which receive fluid from a suitable source. The power nozzle channels taper inwardly to merge with diametrically opposite sides of their corresponding interactive region 228. Axes 262 and 264 of these channels are also offset with respect to their corresponding interaction region 228 to produce a swirling fluid flow in region 228; in the illustrated case each offset is to the left side of the exit orifice 230 to produce a clockwise flow 266. The opposite offsets with respect to the corresponding exit orifices 230 and 232 for the two fluid circuits produce opposite rotational flows from their corresponding outlet orifices. The resulting two generated outlet swirling fluid sprays or cones intersect each other with tangential velocity vectors adjacent the nozzle axis 64 facing the same direction (not shown), whereas in the embodiment illustrated in FIG. 7, the tangential velocities of the first and second sprays or cones at their closest point of intersection in the region of the axis 64 are opposite one another. As illustrated in FIG. 8, the fluid circuits 222 and 224 are slightly divergent across the width of the cup portion of the nozzle so that the enlarged channel ends 246 and 260 merge, as at 278 at the side wall 62.

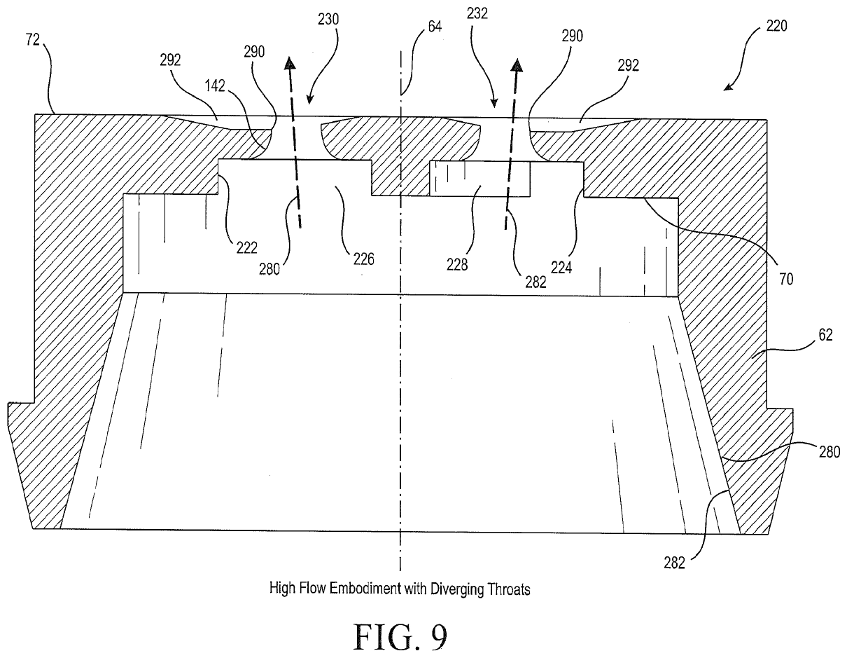

FIG. 9 illustrates in cross-section a configuration of nozzle 220 which has the axes of the exit orifices 230 and 232 of FIG. 8 are modified to be non-parallel, or diverging, as illustrated by orifice axes 280 and 282 which diverge from nozzle axis 64. The diverging exit orifices provide a spray aiming feature designed to reduce the region in which the spray cones formed by the swirling fluid ejected from the two exit orifices intersect, as well as to discourage downstream droplets from coagulating. This diverging spray nozzle assembly 220 incorporates two separate fluid circuits 222 and 224 spaced on opposite sides of the central axis 64 of nozzle 220 as shown in FIG. 8, Fluid circuits 222 and 224 incorporate corresponding interaction or swirl regions 226 and 228 which, as described above with respect to FIG. 8, are defined between their respective opposed power nozzles (not shown in FIG. 9). The swirl regions are lumens, or chambers, of substantially circular section having cylindrical sidewalls surrounding corresponding distally projecting central axes in the distal end wall 68. The chambers are aligned with and surround the respective outlet or exit orifices 230 and 232 to provide fluid communication between each interaction chamber and the exterior of the nozzle 220 so that spray is directed along angled spray axes 280 and 282, which are spaced from but not parallel to the central axis 64.

The foregoing discussion of Applicants' recent work provides a detailed background helpful in describing the fluid dynamics in the three-power-nozzle geometry utilized in the three-power-nozzle apparatus and method of the present invention, which will now be described. In accordance with a preferred embodiment of the invention, further improvements have been made in the spray nozzle assemblies described above, the invention employing three substantially alike power nozzles equally spaced around an interaction chamber and its exit orifice, with the nozzles not being aimed to provide tangential flow, but instead having newly defined angles of attack with power nozzles configured with newly defined offset factors (differing from applicant's two-nozzle HE-MBU devices) to generate surprisingly enhanced atomization.

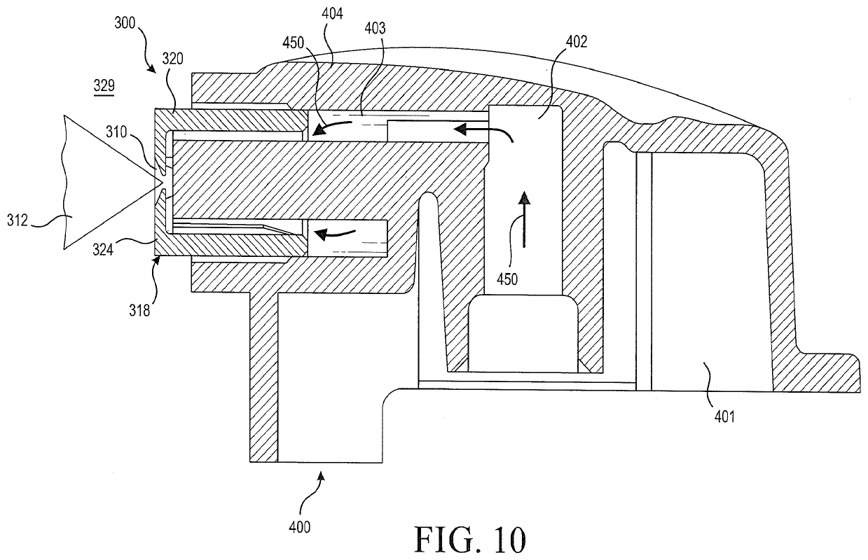

As noted above, the applicants' new “tri-power HE-MBU” nozzle configuration experiments explored something similar to the above-described dimensional parameter referred to as an offset ratio, but with an important difference. The tri-power HE-MBU nozzle configuration of the present invention uses a newly developed Offset Factor, to provide something which differs from the applicants” recently developed power nozzle embodiments. The offset factor is defined as the ratio of power nozzle's width (at its outlet) to the interaction region's diameter (Pw/IRd), and it has been found that the best atomization performance for the three-power-nozzle assembly illustrated in FIGS. 10-12 (to be described) was obtained for a nozzle insert or cup structure 300 incorporating an array of three power nozzles each having an offset factor (Pw/IRd) of between 0.20 and 0.50. An offset factor ratio of 0.2 to 0.3 (more specifically 0.244) was often preferred. Further, the three power nozzles (302, 304 and 306) are each angled with respect to the central axis 322 of interaction chamber 308 so that each power nozzle's angle of attack, or the angle at which liquid jet flow is directed into the interaction region from each power nozzle, is about 40 degrees from a line tangential to the periphery of the interaction chamber at the point of intersection of the center line, or axis, of the power nozzle with the interaction region, to further improve the atomization obtained by the device of this invention. This aiming of the power nozzle flows is intentionally not tangential with the sidewall of interaction chamber 308, as will be described further.

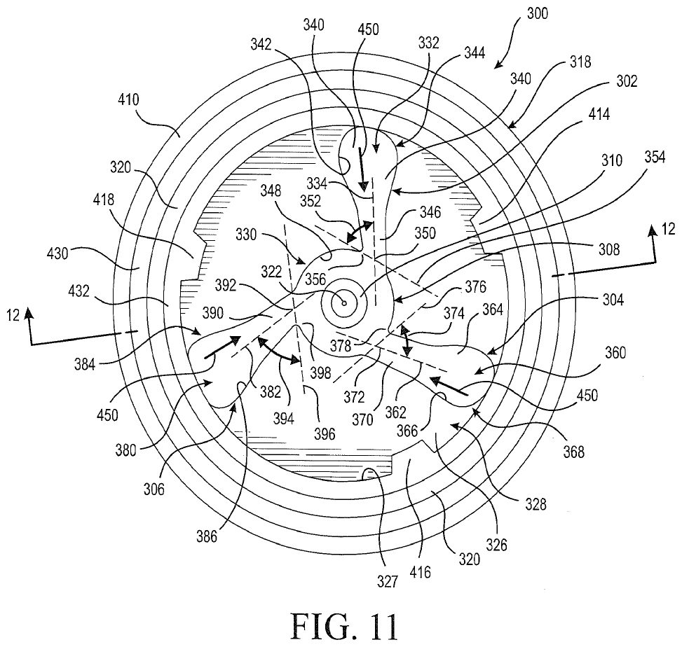

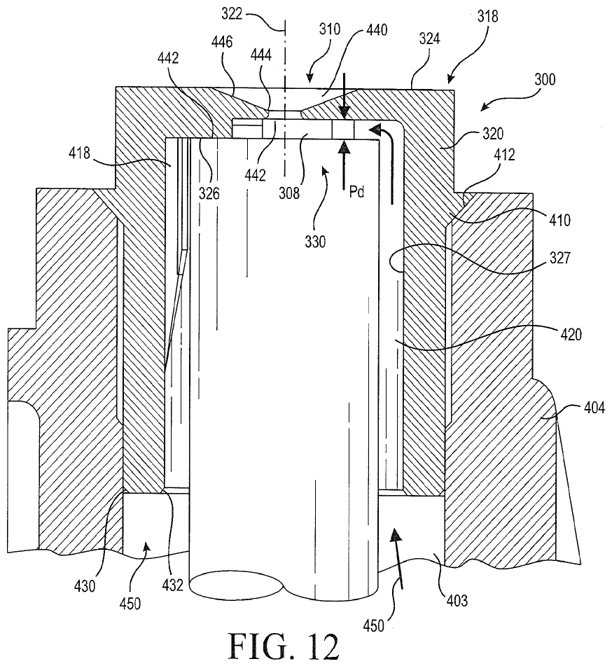

A preferred embodiment of the structure and method of the present invention, illustrated in FIGS. 10-12, includes the cross-sectional view of FIG. 10, the bottom plan view of FIG. 11, and the enlarged cross-sectional view of FIG. 12, which illustrate that fluid nozzle insert or cup member 300 employs a dynamic fluid circuit 330 having first, second and third power nozzles 302, 304 and 306 each configured to direct fluid under pressure into a common interaction region 308. Interaction region or chamber 308 surrounds a central exit orifice 310, and each power nozzle is defined as a trough or groove aligned at a selected angle of attack to direct fluid under pressure into region 308 produce a swirling fluid vortex in this region, where the rotating fluid is then sprayed or ejected from outlet orifice 310 as a spray 312. The first, second and third power nozzles 302, 304 and 306 are preferably substantially alike and equally spaced around the interaction chamber and its central exit orifice, with the nozzles having offset factors and angles of attack differing from prior art devices to generate surprisingly enhanced atomization in fluid spray 312. The nozzle insert or cup member 300 is a dynamic fluid swirl-inducing mist generating structure which utilizes improved and unique power nozzle offset factors and novel angles of attack (e.g., in the range of 30-50 degrees and preferably about 40 degrees) to produce enhanced results.

Nozzle insert or member 300 is used with aerosol and other product spraying packages similar to the applicants' recently developed nozzle members (of FIGS. 2-9), and so includes a cup-shaped body portion 318 formed of a molded plastic or other suitable material. The body portion incorporates a cylindrical sidewall 320 surrounding a central axis 322 and a closed upper (or distal) end generally indicated at 324. The closed end is a substantially circular distal end wall having an interior surface 326. The interior surface of the end wall and the interior surface 327 of the side wall 320 enclose the interior of the cup, generally indicated at 328. The exit aperture or orifice 310 is formed in and through the end wall, and provides fluid communication between the interior 328 of the cup and the exterior of the cup, or ambient atmosphere 329, into which fluid spray generated by nozzle insert 300 is to be directed. Defined in the interior surface 326 of end wall 324 is the novel dynamic fluid circuit 330 (FIG. 11) consisting of the first, second and third power nozzles or channels, 302, 304 and 306 which terminate in interaction region 308, where each power nozzle is defined as a groove or trough to provide a fluid communication channel which extends inwardly along the end wall 324 from the side wall 320 and into the substantially circular central interaction region 308. The dynamic fluid circuit (330) is formed in the inner surface of wall 324 and defines a continuous network of lumens or fluid communication channels with the interaction region 308 surrounding and being concentric to the exit aperture 310.

As illustrated in FIG. 11, first power nozzle 302 is defined by a tapering fluid-accelerating or dynamic fluid channel 332, which forms part of the lumen network of dynamic fluid circuit (330). The channel 332 is formed in the end wall 324 along a longitudinal axis 334, and preferably has a continuous, substantially flat floor 340 and a substantially perpendicular continuous side wall 342 of a selected constant height Pd which defines the channel depth in the end wall 324. The first power nozzle 302 intersects with the generally circular region of interaction chamber 308, which is formed by a continuation of the lumen floor 340 and sidewall 342 and also has a depth Pd. The side wall 342 for the power nozzle 302 is smoothly curved generally around and then generally radially inwardly from an enlarged end region 344 near the inner surface 327 of nozzle wall 320 toward the interaction region, or chamber 308. The power nozzle tapers inwardly toward its axis 334 to form a narrow power nozzle outlet region 346, to produce a narrowing flow path having a minimum width Pw at the intersection of power nozzle 302 with interaction chamber 308.

The outlet region 346 of first power nozzle 302 terminates at, provides fluid communication with and merges into interaction chamber 308, with the nozzle axis 334 of power nozzle 302 intersecting the circumference 348 of the interaction region at a point 350. Axis 334 is at an acute angle 352 with a line 354 tangent to the circumference and passing through point 380. This angle 352 is the angle of attack of the power nozzle with respect to the interaction region, and is in the range of 30-50° and preferably about 40°. The power nozzle's aiming axis 334 is offset from the central spray axis 322 to direct or aim incoming fluid from the power nozzle into the interaction chamber 308 at the desired angle to produce a rotating swirl vortex in the interaction chamber which then flows out of the nozzle outlet 310 through the end wall 324. As illustrated in FIG. 11, the axis of the fluid circuit power nozzle 302, viewed in the direction of input fluid flow, is directed to the left of the central axis 322 to produce a clockwise swirl, or fluid vortex, around the outlet 310. The sidewall on the clockwise side of the first power nozzle 302 (the left sidewall when viewed in the direction of flow) is not tangential but merges smoothly with the interaction chamber sidewall to cause the fluid flow from the nozzle to generate the desired vortex, or swirl, in the interaction region. On the opposite side of the power nozzle outlet 346 (the right sidewall segment when viewed in the direction of power nozzle flow) the side wall 342 bends abruptly at the junction of the power nozzle with the interaction chamber to form a shoulder, indicated, for example, at 356 that causes the clockwise fluid flow in the interaction chamber 308 to bypass the first power nozzle outlet orifice 346. The power-nozzle aiming sidewall segments aim the liquid jet of inrushing fluid of from first power nozzle 302 non-tangentially, in a manner which provides space for that inrushing liquid jet to separate from the interaction region's circumferential side wall and bend upon exiting the power nozzle 302 at outlet orifice 346. The smoothly curved sidewall 342 and narrowing power nozzle lumen cause a smooth flow of fluid into the interaction chamber at higher pressure than that of the fluid supply so it is forced toward and ejected or sprayed from outlet orifice 310 in a fine mist 312 having the desired consistent droplet size.

As also illustrated in FIG. 11, the second power nozzle 304 is defined by a second tapering dynamic fluid channel 360, which forms part of the network of lumen of fluid circuit 330. The second channel 360 is formed in the end wall 324 along a second longitudinal axis 362, and also includes a continuous, substantially flat floor 364, which is a continuation of the floor 340 of first power nozzle 302. The second channel 360 is defined by a substantially perpendicular continuous side wall 366 segment, which is a continuation of the wall 342 of first power nozzle 302. Wall segment 366 has the same selected constant height Pd as does wall 342, and which defines the depth of fluid channel 360 in the end wall 324. The second power nozzle 304 intersects the generally circular region of interaction chamber 308, which is formed by a continuation of the lumen floor 340 and sidewall 342 and also has the same depth Pd. The side wall 366 for the power nozzle 304 is smoothly curved generally around an enlarged end region 368 near the inner surface 327 of nozzle wall 320 and then extends generally radially inwardly toward the interaction region or chamber 308. The second power nozzle also tapers inwardly toward its longitudinal axis 362 to form a narrower power nozzle outlet region 370 and to produce a narrowing flow path having a minimum width Pw at the intersection point 372 of the power nozzle with the interaction chamber.

The second power nozzle's outlet region 370 terminates at, and merges into, the interaction chamber 308, with the nozzle axis 362 of power nozzle 304 intersecting the circumferential wall 348 of the interaction region at a point 372. Axis 362 is at an acute angle 374 with a line 376 that is tangent to the circumference and passing through point 372. This angle 374 is the angle of attack of the power nozzle 304 with respect to the interaction region and is also in the range of 30-50° (preferably about 40°). The axis 362 is offset from the central axis 322 of the nozzle 300 to direct incoming fluid from the power nozzle 304 into the interaction chamber 308 at that desired attack angle to help produce the swirling or rotating vortex in the interaction chamber 308. As illustrated in FIG. 11, the axis of the second power nozzle 304, viewed in the direction of input fluid flow, is directed to the left of the central axis 322 to produce a clockwise swirl, or fluid vortex, around the outlet orifice 310 and spray axis 322. The sidewall 366 on the clockwise side of the power nozzle (the left sidewall when viewed in the direction of flow) is also not tangential but merges smoothly with the interaction chamber sidewall to cause the fluid flow from the nozzle to generate the desired vortex, or swirl, in the interaction region. On the opposite side of the power nozzle outlet region 370 (the right side of the power nozzle when viewed in the direction of flow) the side wall 366 bends abruptly at the junction of the second power nozzle with the interaction chamber to form a shoulder, indicated, for example, at 378 that causes clockwise fluid flow in the interaction chamber to bypass the nozzle outlet at 370. The power-nozzle aiming sidewall segments defining power nozzle 304 aim the liquid jet of inrushing fluid of from second power nozzle 304 in a manner which provides space for that inrushing liquid jet to separate from the interaction region's circumferential side wall and bend upon exiting the second power nozzle 304. The smoothly curved sidewall 366 and narrowing lumen cause a smooth flow of fluid into the interaction chamber at higher pressure than that of the fluid supply which then flows toward outlet orifice 310 to contribute to generating fine mist 312 having the desired consistent droplet size.

As further illustrated in FIG. 11, the third power nozzle 306 is a lumen defined by a tapering walls to provide a fluid-accelerating or dynamic fluid channel 380 which forms a third part of the dynamic fluid circuit 330. The channel 380 is also formed in the end wall 324 along a longitudinal axis 382, and has a continuous, substantially flat floor 384 which is a continuation of the floor 340 of power nozzle 302, and the floor 364 of power nozzle 304. The third power nozzle channel 380 is defined by and includes a substantially perpendicular continuous side wall 386 which is a continuation of the side wall 342 of power nozzle 302 and wall 366 of power nozzle 304 and these define the channel depth in the end wall 324. Wall 386 has the same selected constant height Pd as do walls 342 and 366, and defines the depth of fluid channel 360 in the end wall 324. The power nozzle 306 intersects the generally circular region of interaction chamber 308, which is formed by a continuation of the lumen floor 340 and sidewall 342 and also has the selected depth Pd. The side wall 386 for the power nozzle 306 is smoothly curved generally around an enlarged end region 388 near the inner surface 327 of nozzle wall 320 and then extends generally radially inwardly toward the interaction region, or chamber 308. The power nozzle tapers inwardly toward its axis 382 to form a narrow power nozzle outlet region 390, to produce a narrowing fluid accelerating flow path having a minimum width Pw at the intersection 392 of the third power nozzle with the interaction chamber 308.

The third power nozzle outlet region 390 terminates at and merges into interaction chamber 308, with the nozzle axis 382 of power nozzle 306 intersecting the circumference 348 of the interaction region at a point 392. Power nozzle axis 382 is at an acute angle 394 with a line 396 tangent to the circumference and passing through point 392. This angle 394 is the angle of attack of power nozzle 306 with respect to the interaction region and is also in the range of 30-50° (preferably about 40°). The third power nozzle's axis 382 is also offset from the central axis 322 of the nozzle member 300 to direct incoming fluid from the power nozzle into the interaction chamber 308 at a desired angle to aid in producing and maintaining the swirl vortex in the interaction chamber. As illustrated in FIG. 11, the axis of the third power nozzle 306, viewed in the direction of the third power nozzle's inrushing fluid flow, is also directed to the left of the central axis 322 to help produce and maintain the clockwise swirl, or fluid vortex, around the outlet 310. The power nozzle sidewall (the left sidewall when viewed in the direction of flow) is not tangential but merges smoothly with the interaction chamber sidewall to cause the fluid flow from the power nozzle 306 to help generate the desired vortex, or swirl, in the interaction region. On the opposite side of the power nozzle outlet 390 (the right sidewall when viewed in the direction of flow) the side wall 386 bends abruptly at the junction of power nozzle 306 with the interaction chamber to form a shoulder, indicated, for example, at 398 that causes clockwise fluid flow in the interaction chamber to bypass the third power nozzle's outlet 390. The third power-nozzle's sidewalls aim the third liquid jet of inrushing fluid of from third power nozzle 306 in a manner which also provides space for that inrushing liquid jet to separate from the interaction region's circumferential side wall and bend upon exiting the power nozzle 306. The smoothly curved sidewall 386 and narrowing power nozzle outlet lumen causes a smooth flow of fluid into the interaction chamber at higher pressure than that of the fluid supply so it also rotates and flows to outlet orifice 310 to help generate and maintain a fine mist spray 312 having the desired consistent droplet size.

The first, second and third power nozzles 302, 304 and 306 preferably are all similar to each other, each having substantially the same length, width and depth dimensions, and substantially the same inward taper toward their respective narrow power nozzle outlet regions 346, 370 and 390, to produce similar narrowing flow paths each having a minimum width Pw at their intersections with the interaction chamber. The power nozzles extend inwardly from the inner surface 327 of side wall 320 along respective axes 334, 362, and 382, and all the axes intersect the circumference of the interaction region at corresponding points and preferably at substantially equal acute angles of about 40° with respect to tangential lines passing through the corresponding points. The first, second and third power nozzles 302, 304 and 306 preferably are symmetrically arrayed and equally spaced around the interaction chamber 308.

Each of the three spaced power nozzle outlet regions 346, 370, and 390 terminate at, and merge into, the interaction chamber 308, with the nozzle axes 334, 362 and 382 being angled in the same direction with respect to their respective tangential lines, and with the directions of the axes being offset from the central axis 322 of the nozzle 300. This offset of the power nozzle axes directs the accelerating incoming fluid from each of the first, second and third power nozzles 302, 304 and 306 to enter the interaction chamber 308 at the desired angle to rapidly initiate and maintain a rotating or swirling vortex in the interaction chamber which then sprays out of the nozzle outlet 310 through the end wall 324. As viewed in FIG. 11, the axes of the power nozzles in the direction of input fluid flow are each directed to the side (e.g. left) of the central axis 322 to produce a clockwise swirl, or fluid vortex, around the outlet 310. As illustrated, the sidewall on the clockwise side of each power nozzle (the left sidewall when viewed in the direction of flow) is not tangential but merges smoothly with the interaction chamber sidewall to cause the fluid flow from the nozzle to generate the desired vortex, or swirl, in the interaction region 308. On the opposite sides of the power nozzles (the right sidewall when viewed in the direction of flow) the side walls bend abruptly at the junctions of the power nozzles with the interaction chamber, to form shoulders 356, 378 and 398 that cause the circulating clockwise fluid flow in the interaction chamber 308 to bypass the nozzle outlets, continuing its swirling motion to cause mechanical break-up of fluid into fine droplets which spray from outlet orifice 310 in a rotating fine mist 312 having the desired consistent droplet size.

By limiting the depth Pd of dynamic fluid circuit (330) to be as small as flow requirements and boundary layer effects permit (typically Pd ranges from 0.2-0.5 mm, the velocity of the fluid entering first, second and third power nozzles 302, 304 and 306 is sufficient to generate a vortex in the interaction region with radius r and having a desired higher angular velocity ω=Uθ/r. As noted above, nozzle member 300 works well because of a newly developed parameter called the Offset Factor. The offset factor is defined as the ratio of power nozzle width (Pw) to the interaction region diameter (IRd). In the embodiment illustrated in FIGS. 10-12, Power nozzle width (Pw) or the lateral extent of each power nozzle's narrow outlet (346, 370, 390) at the respective intersection points with interaction chamber 308 (350, 372, 392) is preferably in the range of 0.2 mm to 0.6 mm, and in one preferred embodiment, Pw was about 0.39 mm. For the embodiment illustrated in FIGS. 10-12, the transverse extent or diameter of interaction region 308 (IRd) is preferably in the range of two to five times the selected Power nozzle width (Pw), and good prototype performance was seen with interaction region diameters (IRd) of 0.20 mm to 2.0 mm. This IRd dimension may be increased or decreased based on flow requirements for a particular product's nozzle spray application. Development work with prototypes has enabled the applicants to discover that the best atomization performance (with aerosol fluid products) for the three-power-nozzle member 300 was obtained for a nozzle insert or cup structure incorporating an array of the first, second and third power nozzles 302, 304 and 306 taper to a selected power nozzle outlet width (e.g., 0.39 mm) and have a uniform depth (e.g., 0.28 mm) for a selected interaction region diameter (e.g., 1.6 mm) which exhausts or sprays distally along the central spray axis through an outlet orifice having a selected smallest (throat) diameter (e.g., 0.39 mm). It should be noted that the “offset factor” is not the aimed “offset” of the nozzle axes with respect to the exit aperture described above and illustrated in FIG. 11. The interaction chamber 308 preferably has the same depth Pd as each power nozzle, and is arranged so that the fluid flows from the power nozzles and enters the interaction region with a higher tangential velocity Uθ than the velocity of the fluid entering the nozzles, thus generating a vortex in the interaction region with radius r and a higher angular velocity ω=Uθ/r. The rapidly spinning or swirling vortex then issues from interaction region 308 through the exit aperture which is coaxially aligned with the central axis 322 of the nozzle cup. This configuration causes swirling fluid droplets that are generated in the swirl chamber to accelerate into a highly rotational flow or spray 312 which issues from the exit aperture or orifice 310 as very small droplets which are prevented from coagulating or recombining into larger droplets.

The energy contained in the fluid circulating in interaction region 308 is maintained by limiting the circuit depth Pd to be as small as flow requirements and boundary layer effects permit, typically ranging from 0.2 mm to 0.5 mm. Additionally, the spray-axis length of the cylindrical portion or throat of exit orifice 310 is limited and sharp edges are filleted where possible. The preferred exit orifice profile reduces shear losses and maximizes cone angle to discourage coagulation. Lastly, the three-power-nozzle embodiment may also be configured with multiple exit orifices (e.g., one similar to 310 and another, not shown) in a single cup shaped nozzle member.

As illustrated in FIG. 12, the cup-shaped nozzle 300 is mountable in a fluid spray dispenser head 400 mounted on or forming a part of a fluid container 401 for fluid to be sprayed by way of a dispenser channel 402. The spray head incorporates a fluid chamber, or bore 403, defined by a tubular outer wall 404 and a central cylindrical sealing post 406, which securely receives the nozzle insert or cup 300 as by a friction fit or a snap fit (e.g., with optional retaining barbs, not shown). The cup-shaped insert 300 which is inserted in bore 403 fits over the sealing post and may optionally include an upper, outwardly extending flange 410 formed on the nozzle body portion 318 and arranged to engage an outwardly flared shoulder 412 at the end of outer wall 404 to position the nozzle 300 in the bore 403. A plurality of, preferably three, longitudinal, or axially extending alignment ribs 414, 416 and 418 are formed on the inner surface 360 of the side wall 320 of insert 300 to engage and space the nozzle wall from the outer surface of sealing post 406. These ribs position the nozzle member around the sealing post to define a fluid flow channel 420 between the sealing post and the inner surface 327 of the cup shaped member or insert. The channel 420 leads from the bore 403 to the fluid circuit enlarged end regions 346, 368 and 388 which serve as fluid inlet lumens to the first, second and third power nozzles 302, 304 and 306 of the dynamic fluid circuit 330. The distal end 422 of the sealing post engages the inner surface 326 of the nozzle end wall to close, or seal, the bottom of the fluid circuit 330 to confine the fluid to the nozzles and the interaction chamber. It will be noted that in the illustrated embodiment of the invention, the bottom end of the nozzle side wall 320 is beveled, as at 430 and 432, to facilitate positioning the nozzle member in the bore 403.

Referring now to FIGS. 10 and 12, exit aperture 310 of the nozzle 300 is in some respects similar to that illustrated in FIG. 6, and incorporates an outlet or exit geometry optimally configured in end wall 324, but the surfaces defining exit orifice 310 do a better job of minimizing fluid shear losses and maximize the spray cone angle for spray 312. The geometry is characterized as a non-cylindrical exit channel 440 having a substantially circular cross-section and has a proximal converging entry segment 442 which has a rounded shoulder of gradually decreasing inside diameter (from the interior of the nozzle) and a rounded central channel segment 444 which is upstream of the converging entry segment and defines a minimum exit diameter segment with little to no cylindrical land. Downstream of segment 444 the exit aperture opens sharply at 446, leaving a sharp exit edge. The vortex generated in interaction region 308 flows distally into entry segment 442 of the exit aperture, through the minimum diameter segment 444 and out of the exit aperture to the ambient atmosphere, as indicated by flow 312. The sharp edge of the exit aperture simplifies manufacture of the nozzle while making the tooling structure significantly more robust in terms of tool side alignment, tool wear, and required maintenance.

In the operation of nozzle insert 300, a pressurized inlet fluid product 450 (FIG. 12) flows from a suitable dispenser spray head into the interior of the nozzle through flow channel 420, toward and into the fluid inlet lumens of the power nozzles 302, 304 and 306 formed and defined in the interior surface of the distal wall 324. The pressurized inlet fluid 450 flows distally along the interior surface 327 of the cylindrical sidewall toward the power nozzles, and upon reaching the wall 324 enters the enlarged regions of the power nozzle lumens where it is directed inwardly toward the interaction region 308 and the exit aperture 310. The axes 334, 362, and 382 of the first, second and third power nozzles 302, 304 and 306 are offset with respect to the axis 322 of exit 310, and are angled with respect to corresponding lines tangent to the circumference of the interaction region to provide a selected angle of attack for the incoming fluid. The inward taper of the power nozzle lumens accelerates the fluid flowing along them toward the intersection of the power nozzle outlets with the interaction chamber. The offset and the acute angle of attack cause the fluid jets entering the interaction chamber to bend away from the interaction region wall and initiate and maintain a swirling rotating motion in the flowing fluid, forming a vortex in the fluid which flows distally along central spray axis 322 out of the exit aperture so that a substantially symmetrical conical fluid spray of fine, uniformly sized small uncoagulated droplets 312 is directed along the central axis 322 distally out and away from nozzle 300.

The three-power-nozzle embodiment illustrated in FIGS. 10-12 utilizes a different geometry which utilizes a newly discovered set of relationships (offset factor), it being found in tests of the device of the present invention that the best atomization performance was measured to occur for an offset factor which is between 0.20 and 0.50 mm. The preferred offset factor for nozzle insert 300 was found to be 0.244. With respect to the angle of attack, which is the angle at which flow is directed into the interaction region 308 in the three-power-nozzle embodiment of the invention, it has been determined by applicants that the power nozzles should be angled 40 degrees from tangent (or in the range of 30-50°). This provides space for the liquid jets from the first, second and third power nozzles 302, 304 and 306 to separate from the interaction region wall and bend as they flow away from the power nozzle outlets.

The three-power-nozzle embodiment of the invention 300 improves efficiency by employing the flow field set up in the interaction region to accelerate the three liquid jets without the need for immense converging walls in the power nozzles, which rob the flow of kinetic energy, allowing generation of large angular velocities and superior atomization performance. The shapes and interconnections among the lumens defined by the power nozzles and interaction region of the present invention serve to maintain the energy contained in the interaction region by limiting the circuit depth to be as small as flow requirements and boundary layer effects permit.

Additionally, the present invention benefits from limiting the spray-axis length of exit orifice 310 which reduces shear losses and maximizes cone angle to discourage coagulation. As noted above, The work to develop nozzle insert 300 (as illustrated in FIGS. 10, 11 and 12) was intended to overcome the problems of the prior art and reliably generate and maintain a spray of fine mist-like droplets of selected size and velocity, partly by avoiding coagulation or coalescence after atomization (as described above). The applicants have learned that coagulation is best avoided or mitigated by minimizing droplet collisions and combinations to avoid reformation into larger droplets, resulting in an overall smaller and more uniform particle size distribution. Droplet collisions are minimized by maximizing the cone angle defining spray 312 for a given mass flow rate, so the probability of the coagulation phenomena is reduced.

Nozzle insert 300 does provide further refinements in a High Energy-Mechanical Break-Up (“HE-MBU”) nozzle performance which relies, in part, on the above described outlet configuration where the axial length (along spray axis 322) is as short as possible given present limitations of injection molding. The purpose of the relatively short outlet orifice 310 of nozzle member 300 is to mitigate frictional loses and encourage the unrestricted formation and expansion of a rotating film. The most significant difference in the outlet orifices of this applicant's recently developed (and separately applied-for) MBU Nozzle assemblies (shown in FIGS. 2-9) and nozzle member 300 is that the nozzle assembly of the present invention 300 provides an outlet orifice 310 defining a larger cone angle (or half angle). In accordance with the method of the present invention, by creating the flows described above and directing those flows through outlet orifice 310 and thereby maximizing the cone angle for a given mass flow rate, the probability of the coagulation phenomena occurring is reduced. The two most important orifice dimensions that vary across all HE-MBU embodiments of the present invention include:

(a) the inside diameter of outlet orifice 310, which has been selected to be in a range of 0.20 mm to 1.0 mm. This dimension is varied based on flow requirements of the nozzle spray application; and
(b) the cylindrical land length (along spray axis 322) of outlet orifice 310, which has been selected to be in a range of 0.01-1.0 mm. This dimension is varied based on cone angle requirements of the application. In applicants' recent work this orifice land length should usually be ≤0.05 mm to avoid restricting the cone, but it may be increased for certain spray applications—at the expense of larger droplet size, to prevent the cone of spray 312 from impinging on product packaging.

Although the nozzle assembly and method of the invention are described and illustrated in accordance with a preferred embodiment, it will be understood that variations are possible within the scope of this invention. For example, the first, second and third power nozzles 302, 304 and 306 are shown as substantially equally spaced around the circumference of the interaction region and as having substantially equal offsets and angles of attack, but modifications of these parameters may be made, as by providing different spacing around the circumference, and/or varying the offsets and angles of attack. Further, the three-power-nozzle embodiment of the invention may also be configured with multiple exit orifices in a single cup-shaped nozzle member, including an enhanced swirl inducing mist generating structure for each exit orifice.

Having described preferred embodiments of a new and improved nozzle configuration and method for generating and projecting small droplets in a mist, it is believed that other modifications, variations and changes will be suggested to those skilled in the art in view of the teachings set forth herein. It is therefore to be understood that all such variations, modifications and changes are believed to fall within the scope of the present invention as set forth in the following claims.

1. A spray nozzle insert configured to generate a swirled spray with improved rotating or angular velocity w, resulting in smaller sprayed droplet size, comprising:
a cup-shaped nozzle body having a cylindrical inner side wall surrounding a central longitudinal spray axis and a circular closed end wall; an
outlet orifice or exit aperture coaxial with said central spray axis passing through said end wall;
a dynamic fluid circuit defined in an inner surface of said end wall, said fluid circuit including first, second and third circumferentially spaced inwardly tapered power nozzles terminating in a central interaction region surrounding said exit aperture, said power nozzles being equally spaced around said interaction region and having respective longitudinal aiming axes offset with respect to said exit aperture, whereby fluid under pressure introduced into said fluid circuit flows along said power nozzle chambers into said interaction region to generate a fluid vortex which exits said exit aperture as a swirled spray.

2. The spray nozzle of claim 1, wherein the longitudinal axis of each of said first, second and third circumferentially spaced inwardly tapered power nozzles intersects said interaction region at an acute angle of attack with respect to a line tangent to the interaction region at the point of intersection.

3. The spray nozzle of claim 2, wherein each of said first, second and third power nozzles 302, 304 and 306 has an angle of attack in the range of 30-50° (and preferably about 40°).

4. The spray nozzle of claim 1, wherein said dynamic fluid circuit has a constant depth (Pd) of from about 0.2 mm to about 0.5 mm, and preferably about 0.28 mm).

5. The spray nozzle of claim 1, wherein said central interaction region is circular and has a selected interaction region diameter (IRd);
wherein each power nozzle has a selected power nozzle width at its intersection with said interaction region, and wherein said wherein said selected power nozzle width (Pw) is selected to provide an offset factor (Pw/IRd) of 0.2 to 0.5.

6. The spray nozzle of claim 1, wherein each power nozzle tapers smoothly inwardly from an enlarged region toward a narrow outlet region at the interaction region to accelerate fluid flow.

7. The spray nozzle of claim 6, wherein said power nozzles and said interaction region have a substantially constant depth Pd and wherein each said power nozzle has a minimum width Pw at its narrow outlet region at its intersection with said interaction region.

8. The spray nozzle of claim 7, wherein said interaction region is circular with a diameter IRd which is in the range of two (2) to five (5) times the power nozzle outlet width Pw to provide an offset factor Pw/IRd of between 0.20 and 0.50.

9. The spray nozzle of claim 8, wherein the longitudinal axis of each of said power nozzles intersects said interaction region at an acute angle of attack with respect to a line tangent to the interaction region at the point of intersection.

10. The spray nozzle of claim 9, wherein each power nozzle has an angle of attack of about 40°.

11. The spray nozzle of claim 1, wherein said power nozzles and said interaction region of said dynamic fluid circuit are defined by a continuous wall substantially perpendicular to said end wall.

12. The spray nozzle of claim 11, wherein said interaction region is generally circular and coaxial with said exit aperture.

13. The spray nozzle of claim 12, wherein said nozzle incorporates a single dynamic fluid circuit leading to a single exit aperture coaxial with said nozzle side wall, and wherein said power nozzles are spaced equally around the exit aperture.

14. A method for generating a swirled spray with reduced coagulation and a consistently small droplet size, comprising the steps of:
(a) providing an exit aperture in an end wall of a nozzle body;
(b) forming a dynamic fluid circuit having an interaction chamber surrounding said exit aperture in said end wall;
(c) forming three fluid power nozzles as a part of said fluid circuit and spacing the power nozzles around and intersecting said interaction chamber, the power nozzles having longitudinal axes offset with respect to the exit aperture;
(d) introducing a pressurized fluid into said power nozzles to direct said fluid to into said interaction chamber; and
(e) shaping said power nozzles to accelerate said fluid to generate a fluid vortex in said interaction chamber which exits said nozzle through the exit aperture to produce a swirled output spray.

15. The method of claim 12, further including angling each said power nozzles at an acute angle with respect to a line tangent to said interaction chamber at the point of intersection of the power nozzle with the interaction region to generate said fluid vortex.
